(19) United States
(12) Patent Application Publication
(10) Pub. No.: US 2025/0138267 A1
(43) Pub. Date: May 1, 2025

(54) CABLE RETAINING SYSTEM

(71) Applicant: Telefonaktiebolaget LM Ericsson (PUBL), Stockholm (SE)

(72) Inventors: Sergio MOSTI, Genova (IT); Claudio D'INCÀ, Genova (IT)

(21) Appl. No.: 18/834,025

(22) PCT Filed: Jan. 27, 2023
(86) PCT No.: PCT/EP2023/052090

§ 371 Date: Jul. 29, 2024

Related U.S. Application Data
(60) Provisional application No. 63/304,739, filed on Jan. 31, 2022.

(51) Int. Cl. G02B 6/44

(52) U.S. Cl. CPC G02B 6/44775

(57) ABSTRACT

A cable retaining system is provided. The system comprises: a first retainer, wherein the first retainer is configured to be arranged adjacent to a gasket for sealing an aperture into a housing interior, wherein the first retainer comprises one or more first channels to be aligned with respective openings through the gasket, and wherein the channels are configured to receive respective cables extending through respective ones of the openings in the gasket in order to maintain alignment of longitudinal axes of the cables with the respective openings; and a second retainer, wherein the second retainer comprises a second retainer mechanism spaced apart from the first retainer, wherein the second retainer mechanism is configured to engage the cables to resist movement of the cables out of the first channels.

### TECHNICAL FIELD

The present disclosure relates to a cable retaining system and is particularly, although not exclusively, concerned with an optical cable retaining system configured to resist the displacement of one or more optical cables from within a housing into which the optical cables extend.

### BACKGROUND

With reference to FIGS. 1 and 2, a previously proposed housing 2 may be configured to contain one or more components, such as optical or electrical components, within an interior space 4 of the housing. Cables 10, such as optical fibre cables or electrical cables, may be arranged to extend through an aperture 3 in a wall 6 of the housing into the interior space 4, in order to connect to the one or more components.

A gasket 20 may be provided at the aperture 3 through the wall 6 of the housing 2. The housing 2 and the gasket 20 may attempt to maintain a watertight seal between the interior 4 of the housing and its exterior, in order to reduce or prevent ingress of water or other contaminants into the interior 4 of the housing. The gasket 20 may comprise a plurality of openings 22 through which the cables 10 can be inserted into the interior space 4 of the housing.

As depicted, the housing 2 may comprise a cable retainer 8, which defines a plurality of channels 9 for receiving respective ones of the cables 10 extending through the aperture 3 into the interior space 4 of the housing. Longitudinal directions of the channels 9 may be aligned with longitudinal axes of the cables 10 extending through the apertures. Further, the channels 9 may be aligned with respective ones of the openings 22 in the gasket 20. Hence, by arranging the cables 10 within the channels 9, the cable retainer 8 may act to maintain alignment of the cables 10 with the openings 22, to thereby improve the performance of the seal around the cables formed by the gasket 20.

The channels 9 may each comprise a channel bottom 9a, and an open side 9b opposite the channel bottom 9a. During installation of the cables 10, the cables may be inserted into the channels 9 through the open sides 9b of the respective channels. As depicted, the housing 2 may comprise first and second parts 2a, 2b which are coupled together, e.g. by fasteners 2c, in order to form the complete housing. For example, the first part 2a may be a base part which defines the interior space 4 of the hosing, and the second part 2b may be a lid part, which couples to the base part 2a to close the interior space 4.

The channels 9 may be coupled to, e.g. connected to or integrally formed with, one of the first part 2a and the second part 2b. As shown in FIG. 1, the other of the first part 2a and the second part 2b may comprise a plurality of projections 11 aligned with respective ones of the channels 9 when the first part 2a is coupled to the second part 2b. As depicted, the projections 11 may project into the channels 9 in a direction perpendicular to the longitudinal direction of the channels, e.g. through the open sides 9b. The projections 11 may thereby act to retain the cables within the channels 9. For example, the projections 11 may prevent the cables from being displaced in the direction perpendicular to the longitudinal direction out of the channels out through the open sides 9b of the channels.

However, when the interior space 4 is open, e.g. not closed by the first and second parts 2a, 2b of the housing, for example, if the lid part 2b is removed from, or moved (e.g. slid or hinged) relative to, the base part 2a in order to access components within the interior space 4 of the housing, the cables may become displaced from the channels 9 in the direction perpendicular to the longitudinal direction of the channels. In some cases, displacement of the cables may further lead to undesirable displacement of the gasket 20.

### SUMMARY

According to an aspect of the present disclosure, there is provided a cable retaining system. The system comprises a first retainer, wherein the first retainer is configured to be arranged adjacent to a gasket for sealing an aperture into a housing interior, wherein the first retainer comprises one or more first channels to be aligned with respective openings through the gasket, and wherein the channels are configured to receive respective cables extending through respective ones of the openings in the gasket in order to maintain alignment of longitudinal axes of the cables with the respective openings. The system further comprises a second retainer, wherein the second retainer comprises a second retainer mechanism spaced apart from the first retainer, wherein the second retainer mechanism is configured to engage the cables to resist movement of the cables out of the first channels.

The second retainer may be arranged on an opposite side of the first retainer from the gasket.

The system may further comprise a gasket for sealing the aperture into the housing. The gasket may comprise one or more openings through each of which a cable can extend into the interior of the housing.

Walls of the first channels may be configured to engage the cables to resist movement of the cables in longitudinal directions of the cables.

The second retainer may comprise one or more retaining arms configured to engage the cables to resist movement of the cables out of the first channels. The second retainer, e.g. the retaining arms of the second retainer, may be configured to resist movement of the cables in a direction perpendicular to the longitudinal directions of the cables.

The second retainer may comprise a bracket couplable, e.g. detachable couplable, to the housing. Alternatively, the second retainer may be integrally formed with the housing.

The second retainer may comprise one or more second channels aligned with respective ones of the first channels. The second retainer may be configured to receive the cables extending though the first channels within respective ones of the second channels.

Walls of the second channels may be configured to engage the cables to resist movement of the cables in longitudinal directions of the cables. The cables may be insertable into the second channels in a direction perpendicular to the longitudinal axes of the cables. The one or more retaining arms may be arranged to resist movement of the cables in the direction perpendicular to the longitudinal axes of the cables out of the second channels.

The second channels may comprise a channel bottom and an open side opposite the channel bottom. The retaining arms may be provided at the open sides of the second channels and may be arranged to project over the open sides of the second channels in order to restrict movement of the cables out of the open sides. The retaining arms may project over the open sides of the second channels at an angle relative to walls of the second channels, so that a portion of a particular cable arranged at the angle relative to the walls of the second channels is insertable between pairs of the retaining arms on either side of a particular second channel in order to be inserted into the particular second channel.

The second channels may be spaced apart from the first retainer along the longitudinal axes of the cables.

The cables may be optical fibre cables. The housing is an enclosure, cabinet or mast for a telecommunications network.

According to another aspect of the present disclosure, there is provided a housing assembly. The housing assembly comprises a housing having an aperture through a wall of the housing into an interior space of the housing. The housing assembly further comprises a cable retaining system. The cable retaining system comprises a first retainer, wherein the first retainer is configured to be arranged adjacent to a gasket for sealing the aperture into the housing interior, wherein the first retainer comprises one or more first channels to be aligned with respective openings through the gasket, and wherein the channels are configured to receive respective cables extending through respective ones of the openings in the gasket in order to maintain alignment of a longitudinal axes of the cables with the respective openings. The cable retaining system further comprises a second retainer wherein the second retainer comprises a second retainer mechanism spaced apart from the first retainer, wherein the second retainer mechanism is configured to engage the cables to resist movement of the cables out of the first channels.

The assembly may further comprise the gasket for sealing the aperture into the housing, wherein the gasket comprises one or more openings through the gasket for respective cables to extend through into the housing interior.

The second retainer may comprise one or more retaining arms configured to engage the cables to resist movement of the cables out of the first channels

The first and/or second retainer may be integrally formed with housing. The housing May be an enclosure, cabinet or mast for a telecommunications network. The cables may be optical fibre cables.

According to another aspect of the present disclosure, there is provided a method of retrofitting a retaining system for a housing. The method comprises providing a housing assembly, the housing assembly comprising: a housing having an aperture into an interior of the housing through which one or more cables extend and a first retainer, wherein the first retainer is configured to be arranged adjacent to a gasket for sealing the aperture into the housing interior, wherein the first retainer comprises one or more first channels to be aligned with respective openings through the gasket, and wherein the channels are configured to receive respective cables extending through respective ones of the openings in the gasket in order to maintain alignment of a longitudinal axes of the cables with the respective openings. The method further comprises coupling a second retainer to the housing assembly wherein the second retainer comprises a second retainer mechanism spaced apart from the first retainer, wherein the second retainer mechanism is configured to engage the cables to resist movement of the cables out of the first channels.

The second retainer may comprise one or more retaining arms configured to engage the cables to resist movement of the cables out of the first channels. The method may further comprise arranging the cables such that the cables engage the retaining arms.

The second retainer may comprise one or more second channels alignable with respective ones of the first channels. The second retainer may be configured to receive the cables extending though the first channels within respective ones of the second channels. The method may further comprise arranging the cables such that the cables are received within the ones of the second channels of the second retainer which are aligned with the first channels of the first retainer within which the cables are received.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a previously proposed housing assembly;

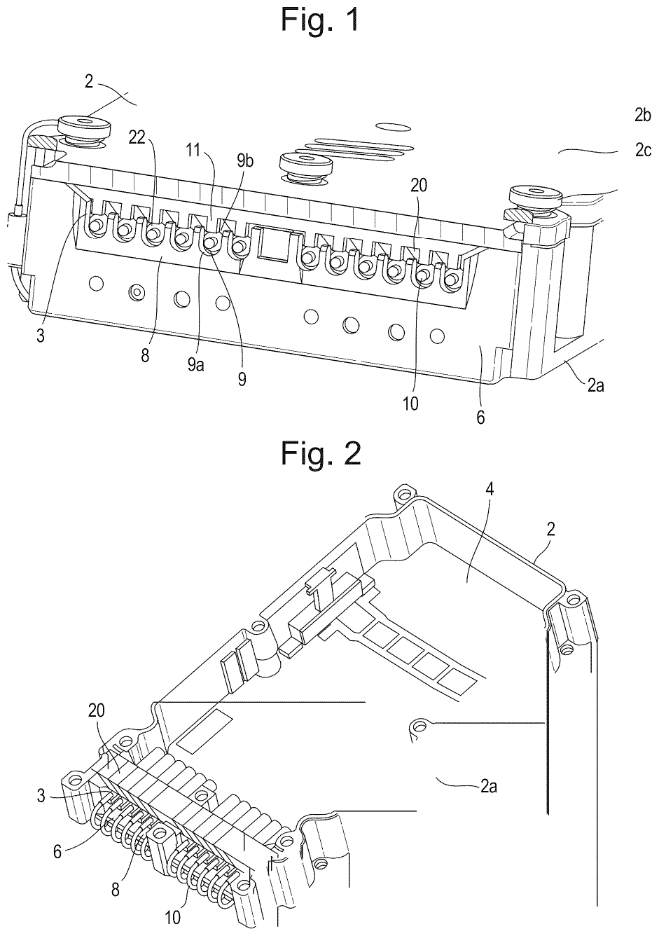

FIG. 2 is a perspective view of the previously proposed housing assembly shown in FIG. 1 with a lid part of the housing omitted;

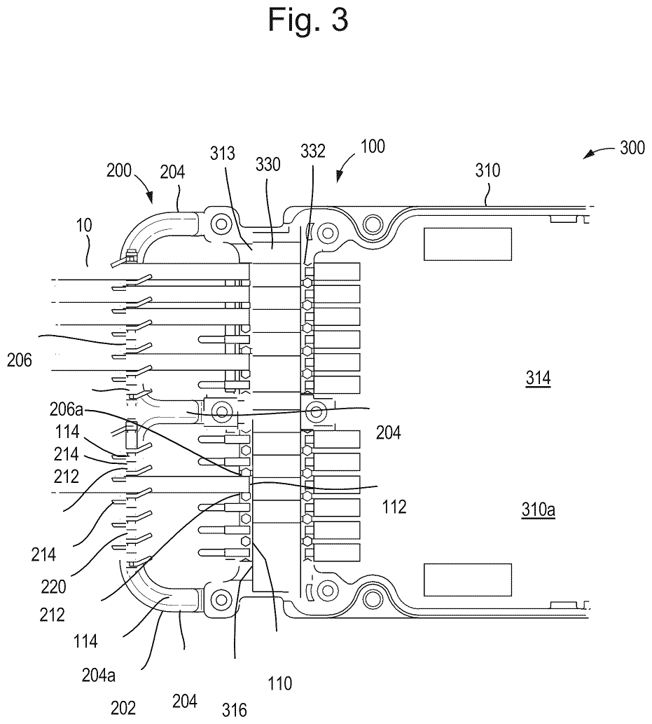

FIG. 3 is a partial top view of a housing assembly according to arrangements of the present disclosure, with a lid part of the housing omitted;

FIGS. 4a and 4b are a partial perspective views of the housing assembly shown in FIG. 3;

FIGS. 5a, 5b, and 5c are partial side, top and front views of a second retainer for a cable retaining system provided within the housing assembly shown in FIGS. 4a and 4b;

FIG. 6 is a perspective view of the second retainer shown in FIGS. 5a, 5b and 5c; and

FIG. 7 is a flow chart illustrating a method of retrofitting a cable retaining system according to arrangements of the present disclosure.

### DETAILED DESCRIPTION

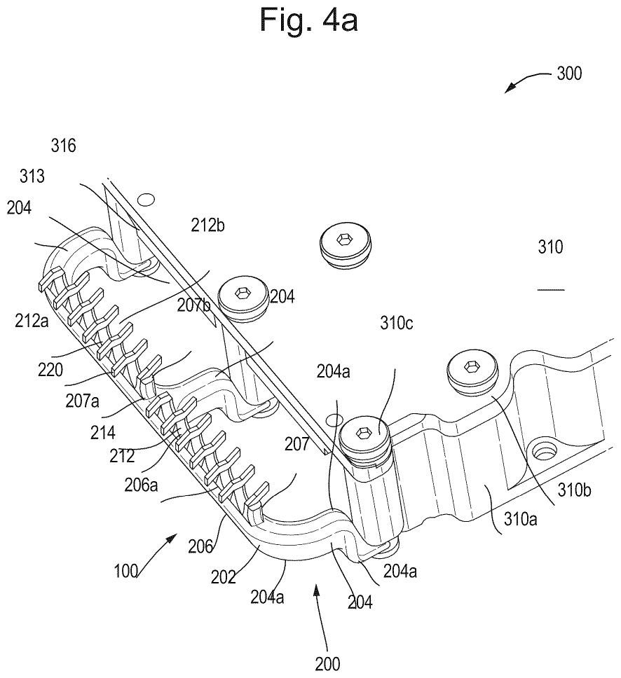

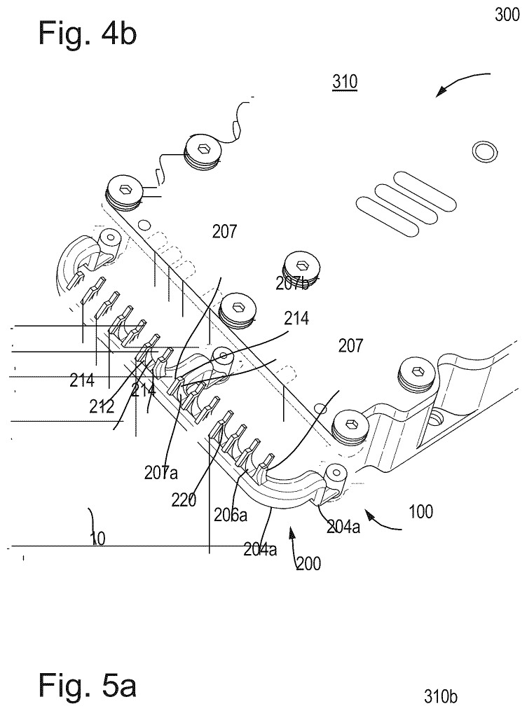

With reference to FIGS. 3, 4a and 4b, a cable retaining system 100 according to arrangements of the present disclosure, may be provided as part of a housing assembly 300. The housing assembly 300 comprises a housing 310 and the cable retaining system 100. In some arrangements, the housing 310 may be an enclosure or cabinet, e.g. for housing optical components, and may be provided as part of a telecommunications network. In some arrangements, the housing 310 may be coupled to, or formed integrally with, a pole or telecommunications mast, e.g. supporting other telecommunications equipment, such as antennae. The cable retaining system 100 may be for retaining optical fibre cables.

The housing 310 may be similar to the housing 2 described above and may comprise an interior space 314 for receiving components, such as optical and/or electrical components to be housed. The housing 310 comprises an aperture 313 through a wall 316 of the housing into the interior space 314. The housing assembly 300 may further comprise a gasket 330 provided at the aperture 313 and configured in a similar way to the gasket 20 described above. In particular, the gasket 330 may comprise a plurality of openings 332 through which cables 10 can be inserted through the gasket 330 and the aperture 313 into the interior space 314. The gasket 330 may attempt to maintain a watertight seal between the interior space 314 of the housing and its exterior, in order to reduce or prevent ingress of water or other contaminants into the interior space 314 of the housing, whilst permitting the cables to extend through the aperture 313 into the interior space 314.

The cable retaining system 100 comprises a first retainer 110 and a second retainer 200. The first retainer 110 is arranged at or adjacent to the gasket 330 or the aperture 313 into the housing. As depicted, the first retainer 110 may be provided on an exterior side of the gasket 330 relative to the interior space 314. The first retainer 110 may be similar to the cable retainer 8 described above. In particular, the first retainer 110 may comprise one or more first channels 112 for receiving respective cables 10 extending through the aperture 313 into the housing. Longitudinal directions of the first channels 112 may be aligned with longitudinal directions of the cables 10. Further, the first channels 112 may be aligned with respective ones of the openings 332 in the gasket 330. Hence, by arranging the cables 10 within the first channels 112, the first retainer 110 may act to maintain alignment of the cables 10, e.g. longitudinal axes of the cables, with the openings 332, to thereby improve the performance of the seal around the cables formed by the gasket 330.

The first retainer 110, e.g. walls 114 of the first channels 112 provided by the first retainer 110, may be configured to engage the cables 10 received within the first channels 112 to restrict or resist movement of the cables 10 in the longitudinal directions of the cables.

For example, a width, or diameter, of the first channels 112 may be less than a thickness, or diameter, of the cables to be received within the first channels. In a similar way to the channels 9 of the cable retainer 8, the first channels 112 of the first retainer 110 may comprise channel bottoms and open sides into the channels opposite the channel bottoms. During installation of the cables 10, the cables 10 may be inserted into respective ones of the first channels 112 in a first cable insertion direction which is perpendicular to the longitudinal direction of the first channels 112 through the open sides of the first channels.

The housing 310 maybe similar to the housing 2 and may comprise a base part 310a and a lid part 310b, which are connected together, e.g. by fasteners 310c, to form the enclosed interior space 314 of the housing. The first retainer 110 may be coupled to, e.g. connected to or integrally formed with, one of the base and lid parts 310a, 310b. The housing 310, e.g. the other of the base and lid parts, may comprise projections or other features for retaining the cables 10 in the first cable insertion direction when the housing 310 is closed, e.g. when base and lid parts of the housing are connected together to close the interior space 314 of the housing.

The cable retaining system 100 further comprises a second retainer 200. The second retainer comprises a second retainer mechanism configured to prevent or restrict displacement of the cables 10, e.g. in the first cable insertion direction. The second retainer 200 may, in particular, be useful when the housing 310 is not closed, or when the projections or other features provided on the housing for retaining the cables 10 in the cable insertion direction are otherwise not able to retain the cables 10 within the first channels.

The second retainer 200, i.e. the second retainer mechanism, is at least partially arranged to be aligned with the first retainer 110 adjacent the gasket 330 and/or the aperture 313 into the housing. The second retainer 200 may be arranged at least partially outside of the housing 310. The second retainer 200, i.e. the second retainer mechanism, may comprise one or more retaining arms 220 configured, as described in greater detail below, to engage the cables 10 to resist or restrict movement of the cables out of the first channels 112. For example, the retaining arms 220 may be configured to restrict or resist movement of the cables in the first cable insertion direction, e.g. out of the first channels 112. The retaining arms 220 may be configured to retain the cables 10 in the first cable insertion direction regardless of whether the housing 310 is open or closed. The second retainer 200 may thereby be configured to retain the cables 10 in the first channels 112 when the base part and lid part are disconnected from one another to provide access into the interior space 314 of the housing. The second retainer 200, i.e. the second retainer mechanism, is configured to retain a plurality of cables.

The second retainer 200, i.e. the second retainer mechanism, may comprise one or more second channels 212. The second retainer 200 may be configured to receive the cables 10 extending though the first channels 112 of the first retainer within respective ones of the second channels 212 of the second retainer. The second channels 212 may be aligned with the respective ones of the first channels 112.

In some arrangements, walls 214 of the second channels 212 may be configured to engage, e.g. grip, the cables 10 received within the second channels and resist movement of the cables 10 in longitudinal directions of the cables. For example, a width, or diameter, of the second channels 212 may be less than a thickness or diameter of the cable to be received within the second channels. Alternatively, in other arrangements, the second channels may not be configured to resist movement of the cables in the longitudinal direction of the cables. For example, widths of the second channels, e.g. in a direction perpendicular to the longitudinal direction of the second channels, between the walls 214 may be greater than a diameter or thickness of the cables 10 to be received within the second channels.

The second channels 212 may comprise channel bottoms 212a, which may extend between opposing walls 214 of the second channels. The second channels may further comprise open sides 212b opposite the channel bottoms 212a. During installation of the cables 10 into the second channels, the cables 10 may be inserted into respective ones of the second channels 212 in a second cable insertion direction perpendicular to the longitudinal direction of the second channels 212 through the open sides 212b of the second channels. The second cable insertion direction may be parallel with the first cable insertion direction.

The retaining arms 220 may be arranged to resist or restrict movement of the cables 10 in the second cable insertion direction. In particular, the retaining arms 220 may be arranged to resist or restrict movement out of the cables 10 in the second cable insertion direction out of the second channels 212.

The retaining arms 220 may be provided at the open sides 212b of the second channels and may be arranged to project over the open sides of the second channels in order to resist or restrict movement of the cables out of the open sides of the second channels.

As depicted, the second retainer 200 may comprise a bracket body 202 comprising one or more coupling parts 204 configured to couple to the housing 310 and a body part 206 coupled to, e.g. integrally formed with, the coupling parts 204. The second channels 212 may be formed on the body part 206.

The coupling parts 204 may be shaped to couple to suitable locations on the housing 310 and support the body part 206 relative to the housing such that the second channels 212 are arranged at a suitable position relative to the first channels 112 of the first retainer, as described herein. In the arrangement shown in the Figures, the coupling parts 204 are configured to couple to the housing at locations of the fasteners 310c used for coupling the first part 310a of the housing to the second part 310b. The coupling parts 204 comprise a plurality of bend portions 204a extending between the locations at which the coupling parts couple to the housing 310, and the body part 206. Further, in the arrangements shown in the Figures, the bracket body 202 comprises three coupling parts 204 for coupling to the housing 310 at three locations. However, in other arrangements, a different number of coupling parts 204 may be provided and/or the coupling parts may be differently shaped in order to suitably support the body part 206 relative to the housing 310 and the first retainer 110.

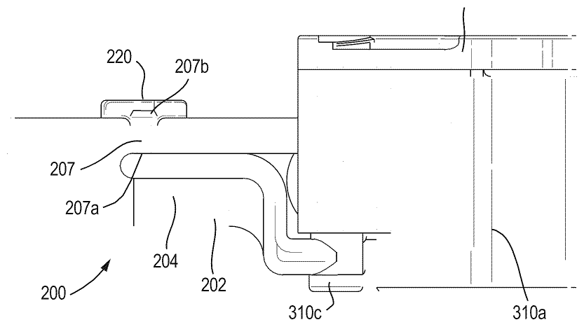

The body part 206 may comprise a plurality of projections 207. The walls 214 of the second channels may be formed by side faces of the projections 207. The bottoms 212a of the channels may be formed by surfaces 206a of the body part extending between the projections 207 at the proximal ends 207a of the projections and the open sides 212b of the second channels may be formed between the distal ends 207b of the projections 207. Referring to FIGS. 5a, 5b and 5c, a length of the projections 207, e.g. between the proximal and distal ends 207a, 207b of the projections, may be greater than or equal to the thickness or diameter of the cables 10 to be received within the second channels 212.

The retaining arms 220 may be coupled to, e.g. integrally formed with, the projections 207 at the distal ends 207b of the projections. As depicted in FIG. 5b, each of the retaining arms 220 may comprise first and second projecting parts 222, 224, which respectively project over the open sides 212b of the second channels 212 formed on either side of the projection 207 to which the retaining arm 220 is coupled.

As illustrated in FIGS. 5b, the retaining arms 220, e.g. the projecting parts 222, 224 of the retaining arms, project over the open sides 212b of the second channels 212 at an angle a relative to walls 214 of the second channels 212. The first and second projecting parts 222, 224 of the retaining arms may be parallel with one another, and with the projecting parts of the retaining arms 220 provided on the adjacent projections 207. A distance, e.g. a minimum distance, between the projecting parts 222, 224 of the retaining arms provided on adjacent projections 207 may be greater than or equal to the widths of the second channels 212, e.g. between the walls 214. Hence, a portion of a particular cable 10 that is to be inserted into a particular second channel 212 between pairs of the retaining arms 220 provided on either side of the particular second channel can be inserted by arranging the portion of the particular cable 10 at the angle α relative to the walls 214 of the second channels 212 at which the projecting parts 222, 224 project. For example, the particular cable 10 may be locally deformed so that the portion of the cable to be inserted between the projecting parts 222, 224 of the retaining arms into the second channel is appropriately arranged. Once the cable has been inserted between the projecting parts 222, 224 of the retaining arms, the cable can then be aligned with the second channel, e.g. such that the longitudinal axis of the cable is parallel with the longitudinal direction of the second channel, so that the cable can be received within the second channel and retained in place between the retaining arms and the surfaces of the second channel.

As depicted in FIG. 5c, cable engaging surfaces 226 of the retaining arms may be configured such that a distance, e.g. height, D_{H} between the channel bottoms 212a and the cable engaging surface 226 is greater than or equal to the thickness or diameter of the cables 10 to be received within the second channels 212.

Returning to FIGS. 3, 4a, 4b and 5a, the second retainer 200 (i.e. the second channels 212) may be spaced apart from the first retainer 110 in the longitudinal direction of the first channels 112, e.g. along the longitudinal axes of the cables 10. For example, the coupling parts 204 of the bracket body 202 of the second retainer may be shaped to support the body part 206 at a position spaced apart from the first retainer 110 in the longitudinal directions of the first channels 112. Arranging the second channels 212 in this way may improve ease of installation of the cables 10 into the second channels 212 between the projecting parts 222, 224 of the retaining arms 220.

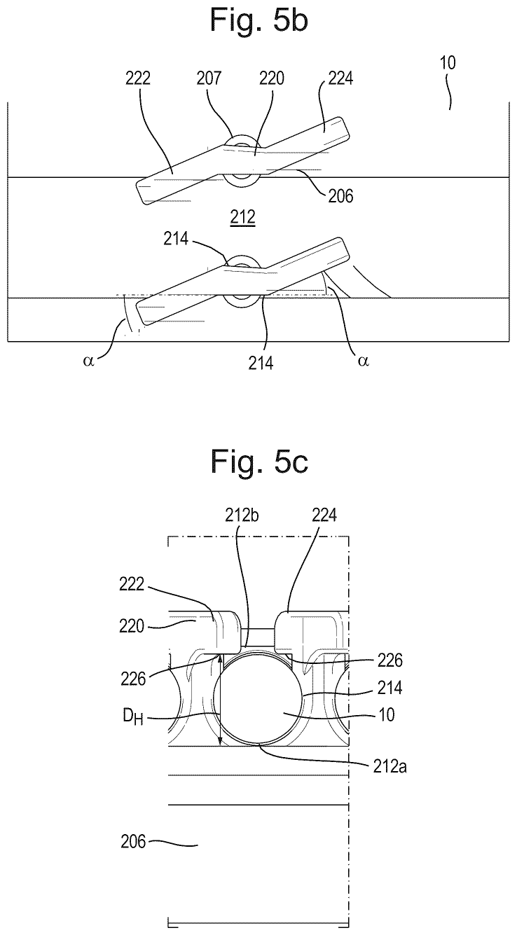

As depicted in FIGS. 6, the second retainer 200 may be attachable to, or detachable from, the housing 310. However, in other arrangements, the second retainer 200 may be integrally formed with the housing 310.

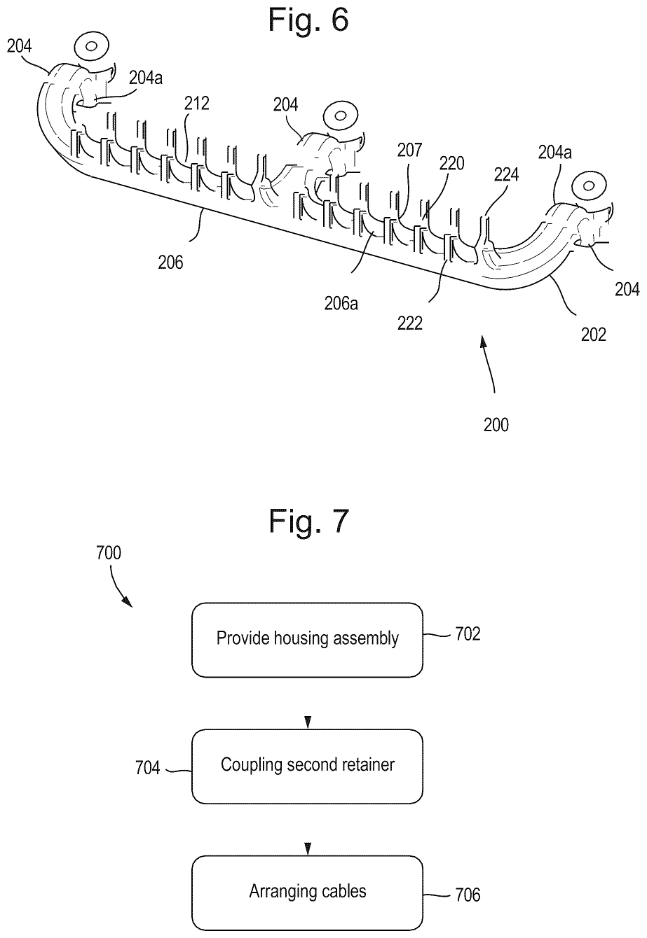

With reference to FIG. 7, a method 700 of retrofitting a retaining system for a housing assembly comprises a first step 702 at which a housing assembly is provided. The housing assembly comprises a housing having an aperture into the housing through which one or more cables can extend. The housing assembly further comprises a first retainer configured to be arranged adjacent to a gasket for sealing the aperture into the housing interior. The first retainer comprises one or more first channels to be aligned with respective openings through the gasket. The first channels are configured to receive respective cables extending through respective ones of the openings in the gasket in order to maintain alignment of longitudinal axes of the cables with the respective openings. For example, the first retainer may be the first retainer 110 described above.

The method 700 further comprises a second step 704, at which a second retainer is coupled to the housing assembly. The second retainer may be coupled to the housing assembly on an opposite side of the first retainer from the aperture in the housing. The second retainer comprises a second retainer mechanism spaced apart from the first retainer, e.g. comprising one or more retaining arms, configured to engage the cables to resist movement of the cables out of the first channels. For example, the second retainer may be the second retainer 200 described above.

The method 700 may further comprise a third step 706, at which the cables are arranged such that the cables engage the retaining arms of the second retainer.

In some arrangements, the second retainer may comprise one or more second channels aligned with respective ones of the first channels and the second retainer may be configured to receive the cables extending though the first channels within respective ones of the second channels. In the third step 706, the cables may be arranged such that the cables are received within the ones of the second channels of the second retainer which are aligned with the first channels of the first retainer within which the cables are received.

It will be appreciated by those skilled in the art that although the invention has been described by way of example, with reference to one or more exemplary examples, it is not limited to the disclosed examples and that alternative examples could be constructed without departing from the scope of the invention.

1. A cable retaining system, the system comprising:
a first retainer, wherein the first retainer is configured to be arranged adjacent to a gasket for sealing an aperture into a housing interior, wherein the first retainer comprises one or more first channels to be aligned with respective openings through the gasket, and wherein the channels are configured to receive respective cables extending through respective ones of the openings in the gasket in order to maintain alignment of longitudinal axes of the cables with the respective openings; and
a second retainer, wherein the second retainer comprises a second retainer mechanism spaced apart from the first retainer, wherein the second retainer mechanism is configured to engage the cables to resist movement of the cables out of the first channels.

2. The cable retaining system of claim 1, wherein the system further comprises the gasket for sealing the aperture into the housing, wherein the gasket comprises one or more openings through each of which a cable can extend into the interior of the housing.

3. The cable retaining system of claim 1, wherein walls of the first channels are configured to engage the cables to resist movement of the cables in longitudinal directions of the cables.

4. The cable retaining system of claim 1, wherein the second retainer mechanism is configured to resist movement of the cables in a direction perpendicular to the longitudinal directions of the cables.

5. The cable retaining system of claim 1, wherein the second retainer comprises a bracket couplable to the housing.

6. The cable retaining system of claim 1, wherein the second retainer comprises one or more retaining arms configured to engage the cables to resist movement of the cables out of the first channels.

7. The cable retaining system of claim 1, wherein the second retainer comprises one or more second channels aligned with respective ones of the first channels, wherein the second retainer is configured to receive the cables extending though the first channels within respective ones of the second channels.

8. The cable retaining system of claim 7, wherein walls of the second channels are configured to engage the cables to resist movement of the cables in longitudinal directions of the cables.

9. The cable retaining system of claim 7, wherein the cables are insertable into the second channels in a direction perpendicular to the longitudinal axes of the cables, and wherein the one or more retaining arms are arranged to resist movement of the cables in the direction perpendicular to the longitudinal axes of the cables out of the second channels.

10. The cable retaining system of claim 7, wherein the second channels comprise a channel bottom and an open side opposite the channel bottom, wherein the retaining arms are provided at the open sides of the second channels and are arranged to project over the open sides of the second channels in order to restrict movement of the cables out of the open sides.

11. The cable retaining system of claim 10, wherein the retaining arms project over the open sides of the second channels at an angle relative to walls of the second channels, so that a portion of a particular cable arranged at the angle relative to the walls of the second channels is insertable between pairs of the retaining arms on either side of a particular second channel in order to be inserted into the particular second channel.

12. The cable retaining system of claim 1 wherein the second channels are spaced apart from the first retainer along the longitudinal axes of the cables.

13. The cable retaining system of claim 1, wherein the cables are optical fibre cables.

14. The cable retaining system of claim 1, wherein the housing is an enclosure, cabinet or mast for a telecommunications network.

15. A housing assembly comprising:
a housing having an aperture through a wall of the housing into an interior space of the housing; and
a cable retaining system, wherein the cable retaining system comprises:
a first retainer, wherein the first retainer is configured to be arranged adjacent to a gasket for sealing the aperture into the housing interior, wherein the first retainer comprises one or more first channels to be aligned with respective openings through the gasket, and wherein the channels are configured to receive respective cables extending through respective ones of the openings in the gasket in order to maintain alignment of a longitudinal axes of the cables with the respective openings; and
a second retainer, wherein the second retainer comprises a second retainer mechanism spaced apart from the first retainer, wherein the second retainer mechanism is configured to engage the cables to resist movement of the cables out of the first channels.

16. The housing assembly of claim 15, wherein the assembly further comprises the gasket for sealing the aperture into the housing, wherein the gasket comprises one or more openings through the gasket for respective cables to extend through into the housing interior.

17. The housing assembly of claim 15, wherein the second retainer comprises one or more retaining arms configured to engage the cables to resist movement of the cables out of the first channels.

18. The housing assembly of claim 15, wherein the cables are optical fibre cables.

19. The housing assembly of claim 15, wherein the housing is an enclosure, cabinet or mast for a telecommunications network.

20. A method of retrofitting a retaining system for a housing assembly, wherein the method comprises:
providing a housing assembly, the housing assembly comprising:
a housing having an aperture into an interior of the housing through which one or more cables extend; and
a first retainer, wherein the first retainer is configured to be arranged adjacent to a gasket for sealing the aperture into the housing interior, wherein the first retainer comprises one or more first channels to be aligned with respective openings through the gasket, and wherein the first channels are configured to receive respective cables extending through respective ones of the openings in the gasket in order to maintain alignment of longitudinal axes of the cables with the respective openings; and
coupling a second retainer to the housing assembly on an opposite side of the first retainer from the aperture, wherein the second retainer comprises a second retainer mechanism spaced apart from the first retainer, wherein the second retainer mechanism is configured to engage the cables to resist movement of the cables out of the first channels.

21. The method of claim 20, wherein the second retainer comprises one or more retaining arms configured to engage the cables to resist movement of the cables out of the first channels, wherein the method further comprises:
arranging the cables such that the cables engage the retaining arms.

22. The method of claim 20, wherein the second retainer comprises one or more second channels alignable with respective ones of the first channels, wherein the second retainer is configured to receive the cables extending though the first channels within respective ones of the second channels.

23. The method of claim 22, wherein the method further comprises:
arranging the cables such that the cables are received within the ones of the second channels of the second retainer which are aligned with the first channels of the first retainer within which the cables are received.
